(19) United States
(12) Patent Application Publication
(10) Pub. No.: US 2013/0313298 A1
(43) Pub. Date: Nov. 28, 2013

(54) ASSEMBLY FOR MOVING PROJECTION SCREENS FOR HEAD-UP DISPLAYS

(71) Applicants: Martin Leist, Bad Hersfeld (DE); Horst Rumpf, Herborn (DE)

(72) Inventors: Martin Leist, Bad Hersfeld (DE); Horst Rumpf, Herborn (DE)

(73) Assignee: Johnson Controls GmbH, Burscheid (DE)

(21) Appl. No.: 13/823,052

(22) PCT Filed: Sep. 16, 2011
(86) PCT No.: PCT/EP2011/066102

§ 371 Date: Apr. 18, 2013

(30) Foreign Application Priority Data
Sep. 17, 2010 (DE) 10 2010 045 854.6

(51) Int. Cl. B60R 11/00

(52) U.S. Cl. CPC B60R 11/00
USPC 224/545

(57) ABSTRACT

An assembly for moving projection screens for head-up displays, includes a mounting for fastening the projection screen. The mounting is connected to a mechanical coupling gear unit, which has a base member that can be fastened to a vehicle part.

The invention relates to an assembly for moving projection screens for head-up displays. Such projection screens are also designated as combiners.

They are attached to the windshield of a vehicle in the driver's viewing range. Vehicle information is projected onto the projection screen by a TFT display. It is desirable that these projection screens, when not in use, are removed from the vehicle driver's viewing range, this generally taking place by the projection screen being folded away. Furthermore, the projection screens are exposed to high mechanical and thermal stresses which are caused by high temperatures, sunlight and scratch marks. These components therefore usually have to be exchanged more than once during the service life of a vehicle. It may be necessary to adjust the position of the projection screen both at the time of installation and during use. Rotary joints, about the axis of which the projection screen can be pivoted, have to be provided for both movements.

The versions known from the prior art use articulated assemblies, the axis of rotation of which lies at the lower margin of the projection screen or underneath the latter. However, the best optical quality will be achieved if the axis of rotation were to lie at the center or near the center of the projection screen.

The object of the present invention is to provide an assembly of the type initially mentioned, which makes it possible to pivot the projection screen about an axis which is located in the vicinity of the center of the projection screen.

The object is achieved, according to the invention, by means of an assembly in which the mount is connected to a mechanical coupler mechanism having a basic member which can be fastened to a vehicle part.

In an advantageous version, the mechanical mechanism is designed as a four-bar mechanism, in which a coupler is connected to the basic member in an articulated manner via a first and a second connecting member. The mount is fastened to the coupler of the four-bar mechanism.

By means of coupler mechanisms based on four-bar mechanisms, many different forms of movement can be implemented by simple means.

The joints of the mechanism can be designed as mechanical plain or rolling bearing mountings. An especially expedient version uses materially integral joints, preferably in the form of spring joints. Materially integral joints are distinguished by freedom from friction and from maintenance and ensure a long service life.

In a further advantageous embodiment, two mechanisms arranged in parallel are used. Expediently, for this purpose, two four-bar assemblies are coupled, the mount being fastened to a connecting element, to which the two four-bar assemblies are connected.

In order to achieve an identical sequence of movement of the two mechanisms, it is expedient to use two identical four-bar assemblies which are coupled via a connecting element.

In a preferred version, the connecting element is composed of connecting rods which in each case connect the members or joints of the two four-bar assemblies.

The invention is explained in more detail by means of the accompanying diagrammatic figures.

In the associated drawings:

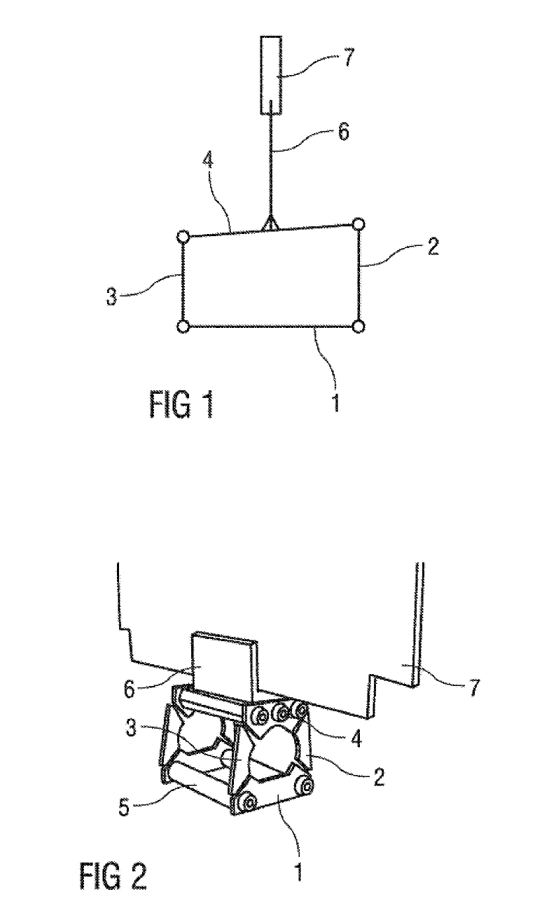

FIG. 1 shows a diagrammatic illustration of the four-bar assembly, and

FIG. 2 shows a perspective illustration of a possible embodiment with two four-bar assemblies.

FIG. 1 shows diagrammatically a four-bar mechanism assembly with a basic member 1 fixed to a framework. The ends of the basic member 1 are connected to a first connecting member 2 and a second connecting member 3 by means of rotary joints. The connecting members 2 and 3, in turn, are connected in an articulated manner to the coupler 4. The mount 6, to which the projection screen 7 is attached, is fastened to the coupler 4.

In the embodiment illustrated in FIG. 2, two identical four-bar assemblies are used, which are coupled to one another by means of a connecting element. A fastening facility for the mount 6 is located on the connecting element. The connecting element is composed of four connecting rods 5 which in each case connect similar members or similar joints of the two four-bar assemblies.

Depending on the dimensions and length relationships of the members 1 to 4, movement curves intended for the mount 6 connected with the coupler 4 and therefore also for the projection screen 7 can be implemented, in particular also those which execute the desired tilting movement of the projection screen.

### LIST OF REFERENCE SYMBOLS

1 Basic member

2 First connecting member

3 Second connecting member

4 Coupler

5 Connecting rod

6 Mount

7 Projection screen

1. An assembly for moving a projection screen for a head-up display, comprising:
a mount for fastening the projection screen; and
a mechanical coupler mechanism connected to the mount and having a basic member configured to be fastened to a vehicle part.

2. The assembly as claimed in claim 1, wherein the mechanical coupler mechanism includes a four-bar assembly, in which a coupler is connected to the basic member by joints via a first connecting member and a second connecting member, and the mount is fastened to the coupler of the four-bar assembly.

3. The assembly as claimed in claim 2, wherein the joints are designed as materially integral joints.

4. The assembly as claimed in claim 2, wherein the mechanical coupler mechanism includes two four-bar assemblies arranged in parallel.

5. The assembly as claimed in claim 4, wherein the two four-bar assemblies are coupled via a connecting element and the mount is fastened to the connecting element.

6. The assembly as claimed in claim 5, wherein the two four-bar assemblies are of identical design.

7. The assembly as claimed in claim 6, wherein the two four-bar assemblies are coupled to connecting rods.

8. The assembly as claimed in claim 6, wherein a component, on which a facility for fastening the mount is arranged, is arranged on the connection.
